(19) United States
(12) Patent Application Publication
(10) Pub. No.: US 2012/0232830 A1
(43) Pub. Date: Sep. 13, 2012

(54) METHOD FOR ESTIMATING LIGHT SCATTERING

(76) Inventors: Cyril Delalandre, Cesson Sevigne Cedex (FR); Pascal Gautron, Cesson Sevigne Cedex (FR); Jean-Eudes Marvie, Cesson Sevigne Cedex (FR)

(21) Appl. No.: 13/508,746

(22) PCT Filed: Nov. 9, 2010
(86) PCT No.: PCT/EP2010/067076

§ 371 Date: May 9, 2012

(30) Foreign Application Priority Data
Nov. 16, 2009 (FR) 0958058
Jul. 26, 2010 (FR) 1056087
Jul. 26, 2010 (FR) 1056096

(51) Int. Cl. G06F 15/00; G01N 21/47

(52) U.S. Cl. 702/127

(57) ABSTRACT

The invention relates to a method for estimating the quantity of light scattered by a heterogeneous participating media. In order to improve the display while minimising the required calculation time, the method comprises steps for:
estimation of projection coefficients in a function basis using values representative of density for a set of points of said media that are situated along at least one emission direction of light by a light source, and
estimation of the quantity of light scattered by said media, according to at least one scattering direction of the light, using said estimated projection coefficients.

### 1. DOMAIN OF THE INVENTION

The invention relates to the domain of synthesis image composition and more specifically to the domain of light scattering simulation in a heterogeneous participating media. The invention is also understood in the context of special effects for a live composition.

### 2. PRIOR ART

According to the prior art, different methods exist for simulating the scattering of light in participating media such as for example fog, smoke, dust or clouds. Participating media correspond to media composed of particles in suspension that interact with the light modifying particularly the trajectory and intensity.

Participating media can be broken down into two groups, namely homogenous media such as water and heterogeneous media, such as smoke or clouds. In the case of homogenous participating media, it is possible to calculate analytically the attenuation of the light transmitted by a light source. In fact, due to their homogenous nature, these media have parameters such as the light absorption coefficient or the light scattering coefficient that are constant at any point of the media. Conversely, the light absorption and scattering properties vary from one point to another in a heterogeneous participating media. The calculations required to simulate the scattering of light in such a heterogeneous media are then very costly and it is thus not possible to calculate analytically and live the quantity of light scattered by a heterogeneous participating media. In addition, the media not being scattered (that is to say the scattering of the media being anisotropic), the quantity of light scattered by the media also varies according to the scattering direction of the light, that is to say the direction in which a person views the media. Calculations estimating the quantity of light scattered must then be reiterated for each observation direction of the media by a person in order to obtain a realist display of the media.

To produce the live display of heterogeneous participating media, some methods perform the pre-calculation of some parameters representative of the heterogeneous participating media. Though these methods are perfectly adapted for a studio use in post-production for example and provide a good quality display, these methods are not adapted in the context of live interactive conception and composition of a heterogeneous participating media. Such a method is described for example in the patent application WO2009/003143 filed by Microsoft Corporation and published on 31 Dec. 2008. The purpose of the application WO2009/003143 is a live display application for a heterogeneous media and describes a solution using radial base functions. This solution can not however be considered as a live display solution as some pre-processing must be applied offline to the participating media to be able to calculate projection coefficients representing the media that will be used for image synthesis live calculations.

With the emergence of interactive simulation games and applications, notably in three dimensions (3D), the need is being felt for live simulation methods offering a realistic display of heterogeneous participating media.

### 3. SUMMARY OF THE INVENTION

The purpose of the invention is to overcome at least one of these disadvantages of the prior art.

More specifically, the purpose of the invention is to optimise the required calculation time to compose a realistic live display of the scattering of light in a heterogeneous participating media.

The invention relates to a method for estimating the quantity of light scattered by a heterogeneous participating media, the method comprising steps for:
estimation of projection coefficients in a function basis using light intensity reduction values for a set of points of the media situated along at least one light emission direction by a light source, and
estimation of the quantity of light scattered by the media, according to at least one scattering direction of the light, using estimated projection coefficients.

Advantageously, the estimation of projection coefficients is independent of the wavelength of the light emitted by the light source.

According to a specific characteristic, the projection coefficients are estimated taking into account a predetermined scale factor Δ.

According to a specific characteristic, the method comprises a step of estimation, for each point of the media, of a value representative of the light intensity reduction in a given point of the media.

Advantageously, the estimation of values representative of the light intensity reduction is carried out by discretization of the media.

According to a specific characteristic, the estimation of values representative of the light intensity reduction is carried out using the ray sampling method.

Advantageously, the estimation of the quantity of light scattered by the media is carried out by discretization of the media along the at least one scattering direction.

According to a particular characteristic, the estimation of the quantity of light scattered is carried out using the ray sampling method.

According to another characteristic, the projection coefficients are stored in a projection texture.

### 4. LIST OF FIGURES

The invention will be better understood, and other specific features and advantages will emerge upon reading the following description, the description making reference to the annexed drawings wherein:

FIG. 1 diagrammatically shows a heterogeneous participating media scattering light, according to a particular embodiment of the invention,

FIG. 2 diagrammatically shows a method for estimation of the attenuation of light in a media of FIG. 1, according to a particular embodiment of the invention,

FIG. 3 diagrammatically shows a method for estimation of the quantity of light scattered by a media of FIG. 1, according to a particular embodiment of the invention,

FIG. 4 shows a device implementing a method for estimation of the quantity of light scattered, according to a particular embodiment of the invention,

FIGS. 5 and 6 show a method for estimation of the quantity of light scattered, according to two particular embodiments of the invention.

### 5. DETAILED DESCRIPTION OF EMBODIMENTS OF THE INVENTION

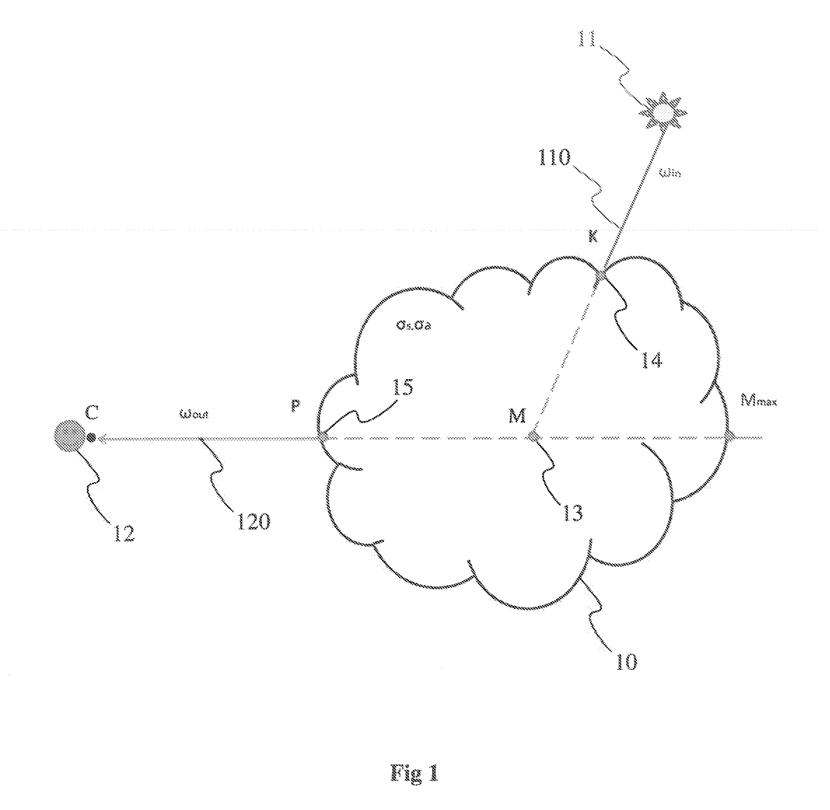

FIG. 1 shows a heterogeneous participating media 10, for example a cloud. A participating media is a media, composed of a multitude of particles in suspension that absorbs, emits and/or diffuses light. In its simplest form, a participating media absorbs only light, for example the light received from a light source 11 such as the sun for example. This means that the light passing across the media 10 is attenuated, the attenuation depending of the density of the media. The media being heterogeneous, that is to say that the physical characteristics of the media, such as the density of particles composing it for example, vary from one point to another in the media. As the participating media is composed of small particles that interact with the light, the incident light, that is to say received from the light source 11 according to one direction ωᵢₙ 110 is not only absorbed but it is also scattered. In an isotropic scattering participating media, the light is scattered uniformly in all directions. In an anisotropic scattering participating media, such as the cloud 10 shown in FIG. 1, the light scattering depends on the angle between the incidence direction ωᵢₙ 110 and the scattering direction ωₒᵤₜ 120 of the light. The quantity of light scattered at a point M 13 of the media 10 in the scattering direction ωᵢₙ 120 is calculated by the following equation:

Q(M, ωₒᵤₜ)=D(M), σ [symbol] , p(M, ωₒᵤₜ, ωᵢₙ), L [symbol] (M, ωᵢₙ) Equation 1

The quantity of light scattered by a point M 13 of the media attaining the eye of the spectator 12 situated at a point C of space in the direction ωₒᵤₜ 120, that is to say the quantity of light scattered by the point M is attenuated by the media 10 on the trajectory M-P, the point P being situated at the intersection of the media 10 and the direction ωₒᵤₜ in the direction of the spectator 12, is then:

Lₚ(M, ωₒᵤₜ)=Q(M, ωₒᵤₜ), exp^{∫}^{_{P}}^{^{M}} ^{D}( [symbol] ), ^{σ} [symbol] Equation 2

wherein
σₛ is the scattering coefficient of the media,
σₐ is the absorption coefficient of the media,
σₜ=σₛ+σₐ is the extinction coefficient of the media,
D(M) is the density of the media at a given point, the density varying from one point to another as the media 10 is heterogeneous,
p(M, ωₒᵤₜ, ωᵢₙ) is the phase function describing how the light coming from the incidence direction ωᵢₙ is scattered in the scattering direction ωₒᵤₜ at the point M,
Lₙ(M, ωᵢₙ) is the reduced light intensity at the point M coming from the incidence direction ωᵢₙ 110 and represents the quantity of incident light arriving at the point M after attenuation due to the trajectory of the light in the media 10 on the segment K-M, K being the intersection point between the media 10 and the incidence ray ωᵢₙ 110, and its value is:

exp^{∫}^{_{M}}^{^{K}}^{-D}( [symbol] )^{σ} [symbol] ^{ds} Equation 3
exp^{∫}^{_{P}}^{^{M}}^{-D}( [symbol] )^{σ} [symbol] ^{ds} represents the attenuation of scattered light due to the absorption and scattering along the path from P 15 to M 13.

Equation 2 enables the quantity of light scattered by a point M and attaining the eye of a spectator 12 situated on the direction ωₒᵤₜ to be calculated. To calculate the quantity of light received by a spectator looking in the direction ωₒᵤₜ, the sum of all the contributions of the set of points of the media situated on the axis ωₒᵤₜ must be calculated, that is to say the points situated on the segment P-Mₘₐₓ, P and Mₘₐₓ being the two intersection points between the media 10 and the direction ωₒᵤₜ 120. This total scattered light arriving at P 15 from the direction ωₒᵤₜ 120 due to simple scattering is then:

L(P, ωₒᵤₜ)=∫_{P}^{Mmax} L_{P}(M, ωₒᵤₜ)dM Equation 4

In this case, it is considered that the light following the trajectory C-P is not attenuated.

This total scattered light is obtained by integration of contributions from all the points situated between P and Mₘₐₓ on a ray having ωₒᵤₜ as direction. Such an integral equation cannot be resolved analytically in general and even less so for a live estimation of the quantity of light scattered. The integral is evaluated digitally using the method known as ray-marching. In this method, the integration domain is discretized into a multitude of intervals of size δ_{M} and the following equation is obtained:

$$L ( P , {ω}_{out} ) \approx {\sum }_{p}^{{M}_{max}} {L}_{p} ( M , {ω}_{out} ) {δ}_{M} \qquad Equation 5$$

Advantageously, the heterogeneous participating media 10 is a three-dimensional dement, shown in two dimensions on FIG. 1 for reasons of clarity.

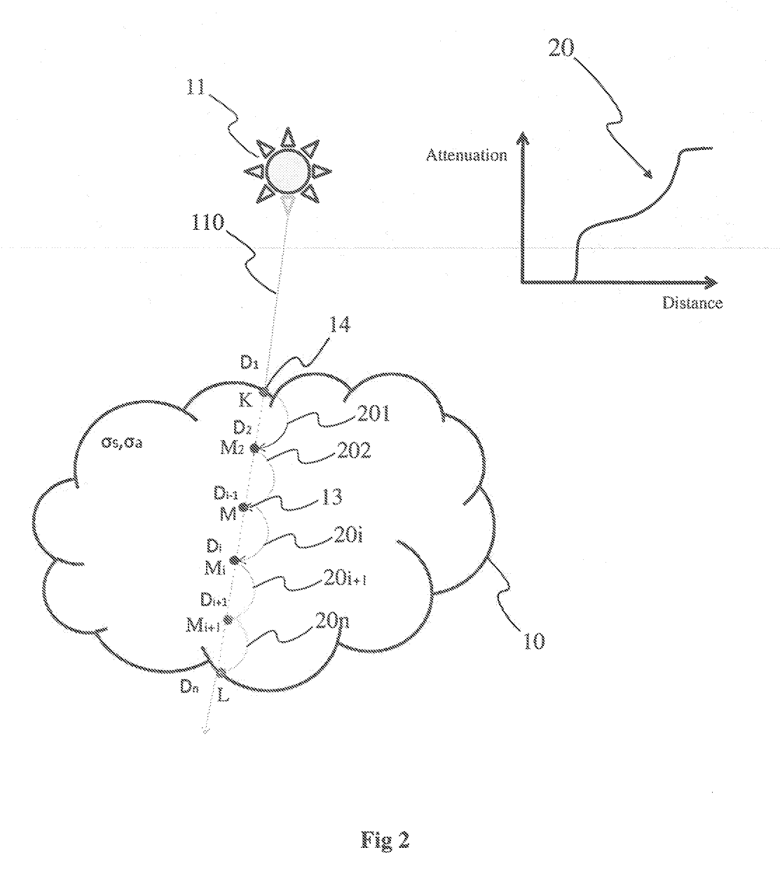

FIG. 2 shows a method for estimation of the attenuation of the light from a light source 11 in the heterogeneous participating media 10, and more specifically the application of the ray marching method to estimate the attenuation of the light in the media 10, according to a particular embodiment of the invention. As has been described with respect to FIG. 1, the scattered light at a point M 13 by the media 10 is a composition of the attenuation of light received by the media 10 from a light source 11 and the scattering of this quantity of attenuated light received by the media 10. Initially, with respect to FIG. 2, the term of the equation 1 representative of the attenuation of the light received from the light source 11 in the media 10 is estimated. The term representative of the attenuation of the simple scattering at a point M of the media 10 is shown by the following equation, equivalent to equation 3:

Att_{L}(M)exp^{∫} [symbol] ^{^{M}} ^{D}( [symbol] )^{σ} [symbol] ^{ds} Equation 6

where
Att_{L}(M) is the attenuation of the light intensity at the point M 13 and represents the quantity of incident light arriving at the point M after attenuation,
D(s) is the density of the media,
σₜ is the extinction coefficient of the media, corresponding to the sum of the scattering coefficient of the media σₛ and the absorption coefficient of the media σₐ (σₜ=σₛ+σₐ).

The media 10 being heterogeneous, its light attenuation varies according to the point M considered. Such an integral type equation cannot be resolved analytically, the number of operations to be carried out being too great, particularly for a live resolution. To estimate the attenuation of light at the point M, the integration domain situated on the incidence direction 110 considered between the input point K 14 of the light ray 110 in the media 10 and a point considered of the media 10 is discretized into a series of intervals 201, 202, 20i, 20i+1, 20n of size δₛ Moreover, the density also varies from one point to another, the density being equal to D₁ in K and to Dᵢ according to the position of the point M, on the incidence ray ωᵢₙ 110. The following equation is then obtained:

$${Att}_{L} ( M ) \approx {\prod }_{K}^{M} {exp}^{- D ( s ) {σ}_{t} {δ}_{s}} \qquad Equation 7$$

Each function of the functional space can be written as a linear combination of base functions, a base function being a base element for a functional space, equation 7 can thus be represented in an equivalent way by:

$${Att}_{L} ( M ) \approx {\sum }_{j = 0}^{N} {c}_{j} {B}_{j} ( M ) \qquad Equation 8$$

where cⱼ is the j^{st} coefficient of the base function Bⱼ and where cⱼ is defined by the sum of i samples going from 0 to N of Att_{L}(xᵢ)·Bⱼ(xᵢ), that is to say:

$${c}_{j} \approx \frac{\vert KL \vert}{N + 1} {\sum }_{i = 0}^{N} [ {Att}_{L} ( {x}_{i} ) \cdot {B}_{j} ( {x}_{i} ] ) \qquad Equation 9$$

xᵢ corresponding to the position at a point Mᵢ on the segment K-L or in an equivalent way to the distance KMᵢ on the line 110.

The extinction coefficient of the media σₜ being dependant on the wavelength of the light emitted by the light source, it may be necessary to calculate a set of base function coefficients for each elementary component of the light, for example the R, G and B (Red, Green, Blue) components, each R, G and B component having a specific wavelength or again the R, G, B and Y (Red, Green, Blue, Yellow) components. To avoid these numerous calculations and thus accelerate the processing necessary for the estimation of these coefficients and also to minimise the memory space required for storage of these base function coefficients, the estimation of base function coefficients is carried out independently of the wavelength of the light emitted by the light source. To do this, the term a is taken from equation 7 that becomes:

$${Att}_{L}^{′} ( M ) \approx {\prod }_{K}^{M} {exp}^{- D ( s ) {δ}_{s}} \qquad Equation {7}^{′}$$

where Att_{L}(M)=(Att′_{L}(M))^{σ}^{ₜ}
Equation 9 thus becomes:

$${c}_{j} \approx \frac{\vert KL \vert}{N + 1} {\sum }_{i = 0}^{N} [ {Att}_{L}^{′} ( {x}_{i} ) \cdot {B}_{j} ( {x}_{i} ] ) \qquad Equation {9}^{′}$$

Equation 9′ being independent of the wavelength of the light emitted by the light source.

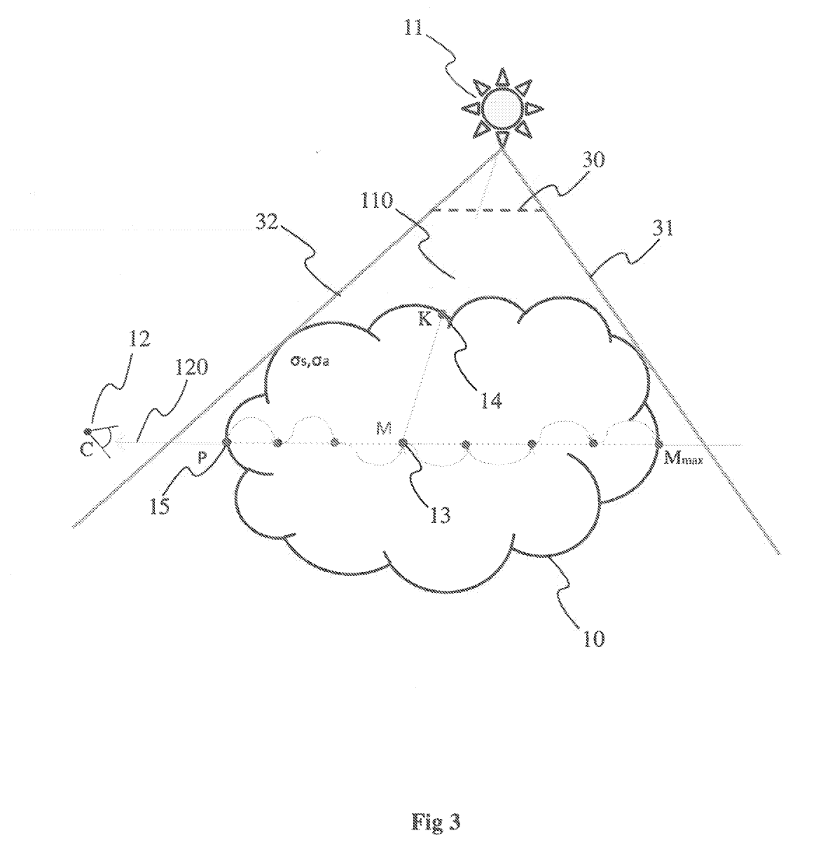

The coefficient σₜ from equation 9′ is taken into account during the estimation of the quantity of light emitted by the point M as will be explained with respect to FIG. 3, particularly in equation 12.

The set, of base function coefficients thus calculated is stored in a projective texture map, such projective texturing being comparable with a shadow map. The calculated coefficients are representative of the attenuation function of the light along the emission direction associated with each element (called texel) of the projective texture map. A graphic representation of the attenuation of the light according to a given direction 110 is made possible using these base function coefficients, as shown in 20 on FIG. 2.

According to a variant, a scale factor Δ is introduced in equation 7 or in equation 7′. This scale factor Δ advantageously enables the influence of the density to be reduced in equations 7 or 7′ and particularly enables the reduction even suppression of ringing artefacts or Gibbs effects, due to the reduced intensity transformation of the light in the functional space, for example in the Fourier space. The equations 7 and 7′ then become according to this variant:

$$\begin{matrix}{Att}_{L}^{Δ} ( M ) \approx {\prod }_{K}^{M} {exp}^{- \frac{D ( s )}{Δ} {σ}_{t} {δ}_{s}} \\ and {Att}_{L} ( M ) = {( {Att}_{L}^{Δ} ( M ) )}^{Δ} & Equation {7}^{″} \\ {Att}_{L}^{′Δ} ( M ) \approx {\prod }_{K}^{M} {exp}^{- \frac{D ( s )}{Δ} {δ}_{s}} \\ and {Att}_{L}^{′} ( M ) = {( {Att}_{L}^{′Δ} ( M ) )}^{Δ} & Equation {7}^{′′′}\end{matrix}$$

The scale factor Δ is advantageously configurable and determined by the user and is for example equal to twice the maximum density of the media, or more than twice the maximum density, for example three or four times the density maximum.

Advantageously, the operations described above are reiterated for each lighting direction (or incidence or light ray direction) leaving from the light source 11 and traversing the media 10. For each light ray, the base function coefficients representative of the light attenuation during the traversing of the media are stored in the projective texture map. The projective texture map then comprises all the projection coefficients representative of the light attenuation in the media. It is thus possible to represent an attenuation curve, such as the curve 20, for each incidence direction of the light from the light source 11. Moreover, equation 9 can be resolved in a reduced number of iterations (for example 10, 50 or 100 iterations) and it is thus possible to calculate the reduced intensity live for a multitude of points of the media 10.

FIG. 3 shows a method for estimation of simple scattering of light in the heterogeneous participating media 10, more specifically the application of the ray marching method to estimate this simple scattering in the media 10, and more generally a method for estimation of scattering of light via the media 10 using base function coefficients calculated previously, according to a particular embodiment of the invention. To calculate the simple scattering of light in the media 10, the ray marching method is implemented according to a non-restrictive embodiment of the invention. Initially, the light attenuation factor of a point M 13 of the media 10 corresponding to the attenuation of the light on the trajectory going from M 13 to P 15, is estimated via the following equation:

att(M)=exp^{∫}^{_{P}}^{^{M}}^{-D}( [symbol] )^{σ} [symbol] ^{ds} Equation 10

The density D(s) of an element (that is to say the point Mᵢ considered, the position of the point Mᵢ going from P to M) of the line segment Mᵢ varying as the media is heterogeneous.

The media being heterogeneous, the equation 10 is very costly in calculating power and thus cannot be calculated analytically. To overcome this problem, a ray marching P-M is carried out according to the direction ωₒᵤₜ and after dicretization of the segment P-M into a multitude of elements δₛ the following is obtained:

$$att ( M ) \approx {\prod }_{p}^{M} {exp}^{- D ( s ) {σ}_{t} {δ}_{s}} \qquad Equation 11$$

Using projection coefficients representative of the attenuation of the light over the incident trajectory of the light from the light source 11 (estimated via equation 8 described with respect to FIG. 2) and stored in a projective texture 30 and from equation 11, it is possible to estimate the overall attenuation of the light at a point M as it is received by a spectator 12 (that is to say composition of the light attenuation in the media 10 according to ωᵢₙ 110 and according to ωₒᵤₜ 120) analytically, the resources in terms of calculating power required being very much leas with respect to those required for an analytic resolution of integral form equations. Using equations 2, 8, 9′ et 11, it is then possible to estimate the quantity of light emitted by a point M 13 of the media and received by a spectator 12 looking in the direction ωₒᵤₜ . The following is thus obtained:

$${L}_{p} ( M , {ω}_{out} ) \approx {σ}_{s} ( M ) \cdot p ( M , {ω}_{out} , {ω}_{in} ) \cdot {Att}_{L} ( M ) \cdot {\prod }_{p}^{M} {exp}^{- D ( s ) {σ}_{t} {δ}_{s}} \\ or \\ {L}_{p} ( M , {ω}_{out} ) \approx {σ}_{s} ( M ) \cdot p ( M , {ω}_{out} , {ω}_{in} ) \cdot {\sum }_{j = 0}^{{N}_{c}} {c}_{j} {B}_{j} ( x ) \cdot {\prod }_{p}^{M} {exp}^{- D ( s ) {σ}_{t} {δ}_{s}} \qquad Equation 12$$

wherein x represents the position of the point M considered on the segment [KL] or in an equivalent manner the distance from K to M along the direction ωᵢₙ 110 and N_{c} represents the number of projection coefficients. Equation 12 represents the quantity of light emitted by a point M and received by a spectator. To obtain the total quantity of light received by a spectator situated at a point C looking in the direction ωₒᵤₜ 120, it suffices to add the sum of quantities of elementary light emitted by the set of points Mᵢ going from P to Mₘₐₓ The following equation is obtained:

$$Q ( C , {ω}_{out} ) \approx {\sum }_{p}^{{M}_{max}} {L}_{p} ( M , {ω}_{out} ) {δ}_{M} \qquad Equation 13$$

To obtain the total quantity of light scattered by the media 10 and received by the spectator, the estimations described above are reiterated for all directions leaving the user and crossing the media 10. The sum of light quantities received by the spectator according to each observation direction provides the quantity of light received from the media 10 by the spectator 12.

According to a variant according to which the coefficients Cj are calculated independently of the extinction coefficient σₜ, equation 12 becomes:

$${L}_{P} ( M , {ω}_{out} ) \approx {σ}_{s} ( M ) \cdot p ( M , {ω}_{out} , {ω}_{in} ) \cdot {( {\sum }_{j = 0}^{{N}_{c}} {c}_{j} {B}_{j} ( x ) )}^{{σ}_{t}} \cdot {\prod }_{P}^{M} {exp}^{- D ( s ) {σ}_{t} {δ}_{s}}$$

According to the variant according to which a scale factor is introduced into the calculation of the attenuation of light in M, equation 12 becomes:

$${L}_{P} ( M , {ω}_{out} ) \approx {σ}_{s} ( M ) \cdot p ( M , {ω}_{out} , {ω}_{in} ) \cdot {( {\sum }_{j = 0}^{{N}_{c}} {c}_{j} {B}_{j} ( x ) )}^{{σ}_{t } Δ} \cdot {\prod }_{P}^{M} {exp}^{- D ( s ) {σ}_{t} {δ}_{s}}$$

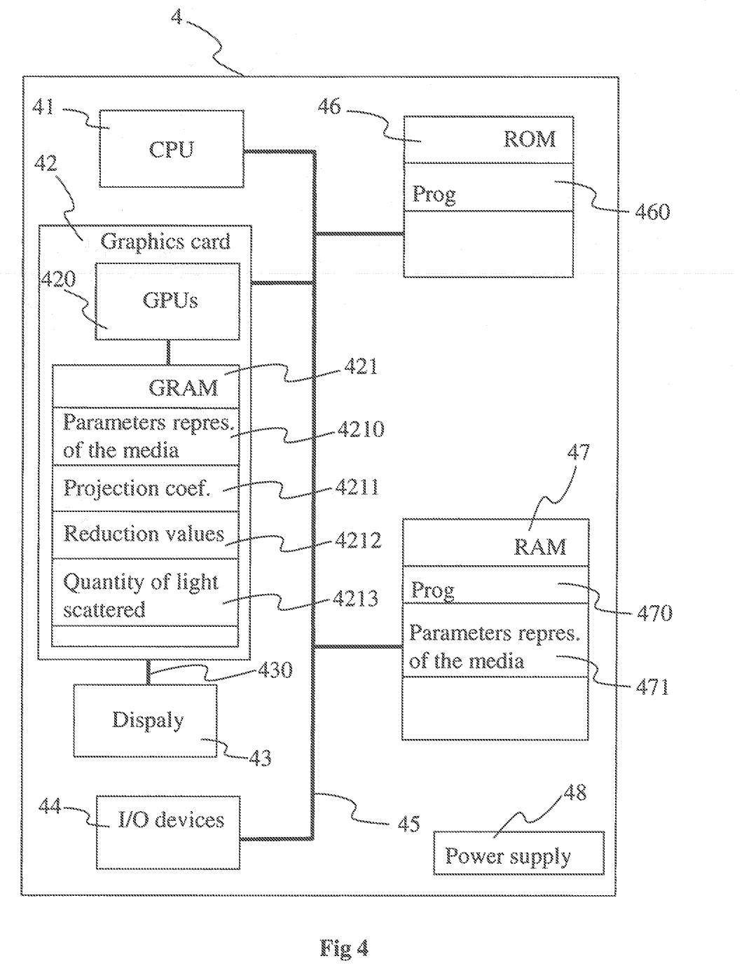

FIG. 4 diagrammatically shows a hardware embodiment of a device 4 adapted for the estimation of the quantity of light scattered via a heterogeneous participating media 10. The device 4 corresponding for example, to a PC personal computer, a laptop or a games console.

The device 4 comprises the following elements, connected to each other by a bus 45 of addresses and data that also transports a clock signal:
a microprocessor 41 (or CPU),
a graphics card 42 comprising:
   several Graphicole Processor Units (or GPUs) 420,
   a Graphical Random Access Memory (GRAM) 421,
a non-volatile memory of ROM (Read Only Memory) type 46,
a Random Access Memory or RAM 47,
one or several I/O (Input/Output) devices 44 such as for example a keyboard, a mouse, a webcam, and
a power source 48.

The device 4 also comprises a display device 43 of display screen type directly connected to the graphics card 42 to display notably the display of synthesized images calculated and composed in the graphics card, for example live. The use of a dedicated bus to connect the display device 43 to the graphics card 42 offers the advantage of having much greater data transmission titrates and thus reducing the latency time for the displaying of images composed by the graphics card. According to a variant, the display device is external to the device 4. The device 4, for example the graphics card, comprises a connector adapted to transmit a display signal to an external display means such as for example an LCD or plasma screen or video-projector.

It is noted that the word “register” used in the description of memories 42, 46 and 47 designates in each of the memories mentioned, both a memory zone of low capacity (some binary data) as well as a memory zone of large capacity (enabling a whole program to be stored or all or part of the data representative of data calculated or to be displayed).

When switched-on, the microprocessor 41 loads and executes the instructions of the program contained in the RAM 47.

The random access memory 47 notably comprises:
in a register 430, the operating program of the microprocessor 41 responsible for switching on the device 4,
parameters 471 representative of the heterogeneous participating media 10 (for example parameters of density, of light absorption coefficients, of light scattering coefficients, of the scale factor Δ).

The algorithms implementing the steps of the method specific to the invention and described hereafter are stored in the memory GRAM 47 of the graphics card 42 associated with the device 4 implementing these steps. When switched on and once the parameters 470 representative of the environment are loaded into the RAM 47, the graphic processors 420 of the graphics card 42 load these parameters into the GRAM 421 and execute the instructions of these algorithms in the form of microprograms of “shader” type using HLSL (High Level Shader Language) language or GLSL (OpenGL Shading Language) for example.

The random access memory GRAM 421 notably comprises:
in a register 4210, the parameters representative of the media 10,
projection coefficients 4211 representative of the reduced light intensity at each point of the media 10,
Light intensity reduction values 4212 for each point of the media 10,
values 4213 representative of the quantity of light scattered by the media 10 according to one or several observation directions.

According to a variant, a part of the RAM 47 is assigned by the CPU 41 for storage of the coefficients 4211 and values 4212 to 4213 if the memory storage space available in GRAM 421 is insufficient. This variant however causes greater latency time in the composition of an image comprising a representation of the media 10 composed from microprograms contained in the GPUs as the data must be transmitted from the graphics card to the random access memory 47 passing by the bus 45 for which the transmission capacities are generally inferior to those available in the graphics card for transmission of data from the GPUs to the GRAM and vice-versa.

According to another variant, the power supply 48 is external to the device 4.

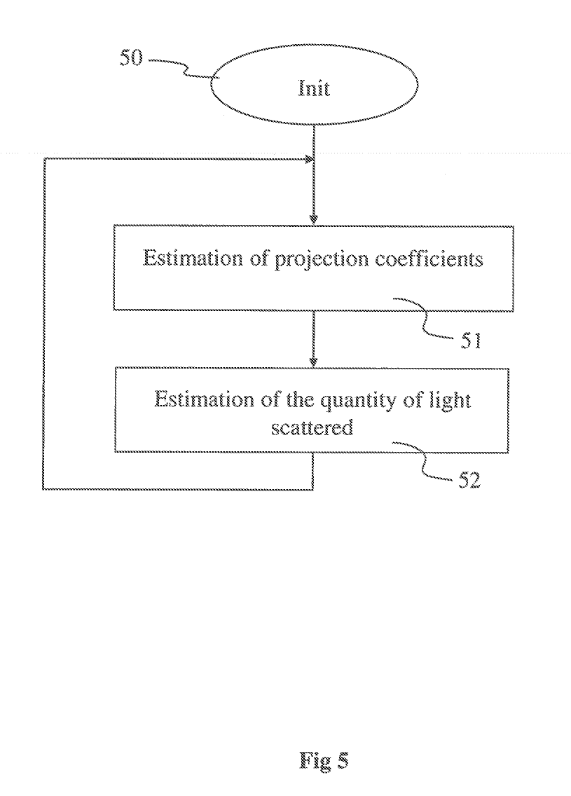

FIG. 5 shows a method for estimation of scattering of light in a heterogeneous participating media implemented in a device 4, according to a first non-restrictive particularly advantageous embodiment of the invention.

During an initialisation step 50, the different parameters of the device 4 are updated. In particular, the parameters representative of the heterogeneous participating media 10 are initialised in any way.

Then, during a step 51, projection coefficients of a base function are estimated, these projection coefficients being representative of the reduction of the light intensity in the heterogeneous participating media 10. To do this, a value representative of the reduction in light intensity is calculated for a set of points representative of a line segment corresponding to the intersection of a light ray 110, from a light source 11, with the media 10. Thus, for each point of the segment considered a value is calculated representative of the reduction of light intensity, this value being minimal at the incidence point K 14 of the ray 110 in the media 10 and being greater and greater as it goes deeper into the media 10 to attain a maximal value at the point L that corresponds to the second intersection point of the light ray 110 with the media 10. The estimation of values representative of the reduction in light intensity is carried out according to any method known to those skilled in the art, for example by discretization of the line segment corresponding to the intersection of the light ray with the media 10. To do this, the segment is for example divided spatially into a multitude of elementary parts of the same length or of different lengths and the reduction of the light intensity is calculated for one point of each elementary part of the segment. The values representative of the reduction of the light intensity of other points of an elementary part are then estimated by interpolation, for example from values calculated for two points of two consecutive elementary parts. Advantageously, the method used to discretize the line segment and to estimate the reduction is light intensity is the method known as the ray-marching algorithm as described with respect to FIG. 2. Then for each value representative of the reduction in light intensity in a point of the media 10 along the ray 110, a projection coefficient of a base function is estimated by the application of equation 9 described in respect to FIG. 2. These projection coefficients are also representative of the reduction in light intensity at points of the media 10.

Advantageously, projection coefficients are estimated for the totality of points, forming the media 10. To do this, the values representative of the reduction in light intensity are estimated for all of the light rays from the light source, traversing the media 10 and comprised between the light rays 31 and 32 delimiting the media 10. Each light segment traversing the media 10 is discretized to deduce the light intensity reduction values, for example by the ray-marching algorithm, then the projection coefficients are deduced by application of equation 9.

Then, during a step 52, the quantity of light scattered by the media 10 according to an emission direction 120 is estimated using projection coefficients estimated previously. To do this the line segment corresponding to the intersection of the emission direction 120 with the media 120, that is to say the segment [PMₘₐₓ] is spatially discretized into a multitude of points or elementary parts representative of this segment. For each point of this segment (respectively each elementary part), equation 12 is applied using the projection coefficient previously estimated. According to a variant, the ray-marching method is implemented to estimate the reduction of light intensity between a point of the segment considered and the point P 15 situated on the periphery of the media 10 in the emission direction 120. The use of projection coefficients representative of the reduction in light intensity according to an incident light ray enables the calculations to be implemented to be simplified while providing a realistic estimation of the reduction of light intensity in a heterogeneous media. No pre-calculation is then required to carry out the display of the scattering of light in a heterogeneous participating media, authorising the live display of such media in interactive applications of video game type for example in which the user is led to move virtually in a space comprising one or several heterogeneous participating media.

Advantageously, the quantity of light scattered by the media 10 is estimated for several emission directions. By adding the sum of these quantities of light estimated for a plurality of emission directions, a total quantity of light scattered by the media 10 and perceived by a spectator observing the media 10 is obtained.

Steps 51 and 52 are advantageously reiterated as a spectator 12 moves around the media 10, the image forming the display of the media 10 being recomposed for each elementary displacement of the spectator 12 around the media 10.

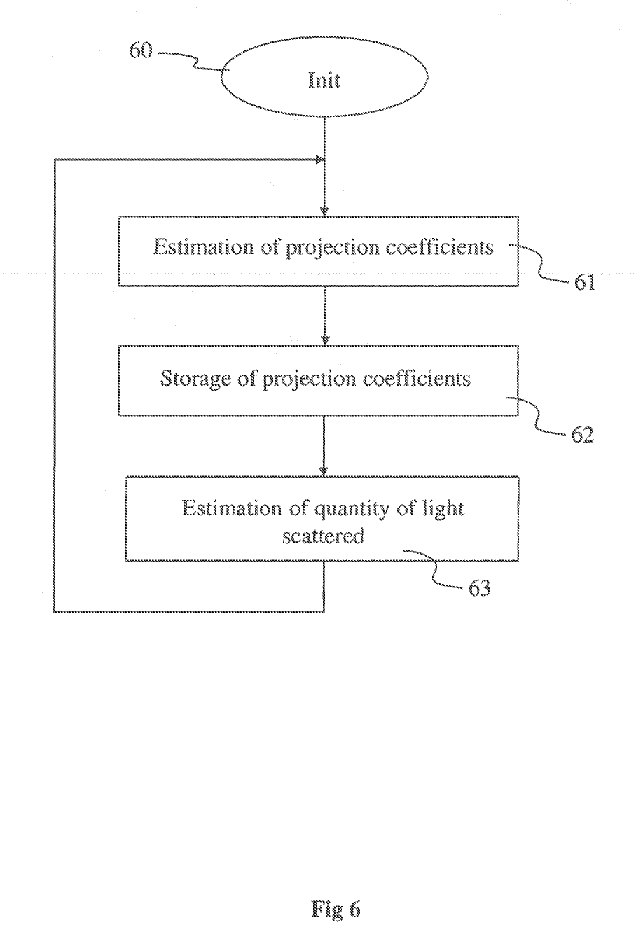

FIG. 6 shows a method for estimation of scattering of light in a heterogeneous participating media implemented in a device 4, according to a second non-restrictive particularly advantageous embodiment of the invention.

During an initialisation step 60, the different parameters of the device 4 are updated. In particular, the parameters representative of the heterogeneous participating media 10 are initialised in any way.

Then, during a step 61, projection coefficients are estimated in the same way as described with respect to step 51 if FIG. 5. Step 61 is thus not further described here.

Then during a step 62, the projection coefficients previously estimated are registered and stored in a projective texture 30. Thus, a storage space of the projective texture is assigned for the storage of projection coefficients estimated for each incident light ray from the light source 11. There are as many storage spaces in the projective texture 30 as there are light rays from the source 11 and traversing the media 10. The projective texture advantageously comprises the set of projection coefficients of the media 10, that is to say a projection coefficient for each point of the media 10. Such storage of projection coefficients offers the advantage of accelerating the calculation of the estimation of the quantity of light scattered by the media 10 and perceived by a spectator, the projection coefficients representative of the reduction of the incident light intensity being available at any moment and immediately for use in equations 12 and 13.

Finally, during a step 63, the quantity of light scattered is estimated in the same way as that described in reference to step 52 of FIG. 5.

Naturally, the invention is not limited to the embodiments previously described.

In particular, the invention is not limited to a method for estimation of the quantity of light scattered by a heterogeneous participating media but also extends to any device implementing this method and notably any devices comprising at least one GPU. The implementation of equations described with respect to FIGS. 1 to 3 for the estimation of coefficients of projection, of reduction of light intensity in the incidence and emission directions, of the quantity of light scattered is also not limited to an implementation in shader type microprograms but also extends to an implementation in any program type, for example programs that can be executed in a CPU type microprocessor.

Advantageously, the base functions used for the estimation of projection coefficients are standard Fourier functions. According to a variant, the base functions used are Legendre polynomials or Tchebychev polynomials.

For example, the scattering method implemented in a device comprising a Xeon® microprocessor with a 3.6 GHz rate nVidia geforce GTX280 graphics card enables the display to be composed of 20 images per second live for a heterogeneous participating media of cloud type composed of 4096 spheres. The use of the invention is not limited to a live utilisation but also extends to any other utilisation, for example for processing known as postproduction processing in a recording studio for the display of synthesis images for example. The implementation of the invention in postproduction offers the advantage of providing an excellent visual display in terms of realism notably while reducing the required calculation time.

The invention also relates to a method for composition of a video image, in two dimensions or in three dimensions, for which the quantity of light scattered by a heterogeneous participating media is calculated and the information representative of the light that results is used for the displaying of pixels of the image, each pixel corresponding to an observation direction according to an observation direction ωₒᵤₜ. The calculated light value for displaying by each of the pixels of the image is re-calculated to adapt to the different viewpoints of the spectator.

The present invention can be used in video game applications for example, whether via programs that can be executed in a PC or portable type computer or in specialised game consoles producing and displaying images live. The device 5 described with respect to FIG. 5 is advantageously equipped with interaction means such as a keyboard and/or joystick, other modes for introduction of commands such as for example vocal recognition being also possible.

1. Method for estimation of the quantity of light scattered by a heterogeneous participating media, wherein the method comprises steps for:
estimation of projection coefficients representative of values of light intensity reduction estimated for a set of points of said media situated along at least one emission direction of light by a light source by projection of said values of light intensity reduction in a functional space of a functions base, and
estimation of the quantity of light scattered by said media, according to at least one scattering direction of the light, using said estimated projection coefficients.

2. Method according to claim 1, wherein the estimation of said projection coefficients is independent of the wavelength of the light emitted by the light source.

3. Method according to claim 1, wherein the projection coefficients are estimated by taking into account a predetermined scale factor Δ, the density of said media being divided by said scale factor for the estimation of projection coefficients.

4. Method according to claim 1, wherein it comprises a step of estimation, for each point of said media, of a value representative of the reduction of light intensity in a given point of said media.

5. Method according to claim 1, wherein said estimation of values representative of the reduction in light intensity is carried out by discretization of said media.

6. Method according to claim 1, wherein said estimation of values representative of the reduction in light intensity is carried out using the ray-marching algorithm method.

7. Method according to claim 1, wherein said estimation of the quantity of light scattered by said media is carried out by discretization of said media along the at least one scattering direction.

8. Method according to claim 1, wherein said estimation of the quantity of light scattered by said media is carried out using the ray-marching algorithm method.

9. Method according to claim 1, wherein said projection coefficients are stored in a projective texture.

10. Device configured for the estimation of the quantity of light scattered by a heterogeneous participating media, wherein the device comprises:
a processing circuit for estimating projection coefficients representative of values of light intensity reduction estimated for a set of points of said media situated along at least one emission direction of light by a light source by projection of said values of light intensity reduction in a functional space of a functions base, and
a processing circuit for estimating the quantity of light scattered by said media, according to at least one scattering direction of the light, using said estimated projection coefficients.

11. Device according to claim 10, wherein the estimation of said projection coefficients is independent of the wavelength of the light emitted by the light source.

12. Device according to claim 10, wherein the projection coefficients are estimated by taking into account a predetermined scale factor Δ, the density of said media being divided by said scale factor for the estimation of projection coefficients.
